(19) United States
(12) Patent Application Publication
(10) Pub. No.: US 2008/0127248 A1
(43) Pub. Date: May 29, 2008

(54) INFORMATION NOTIFICATION METHOD AND DIGITAL TV USING THE SAME

(75) Inventor: Chia-Hung Lin, Taoyuan County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignees: QISDA CORPORATION, Taoyuan Shien (TW); BENQ CORPORATION, Taipei (TW)

(21) Appl. No.: 11/934,879

(22) Filed: Nov. 5, 2007

(30) Foreign Application Priority Data
Nov. 23, 2006 (TW) 95143425

(51) Int. Cl. H04N 7/025

(52) U.S. Cl. 725/32

(57) ABSTRACT

An information notification method is applied to a multimedia home platform (MHP) and a digital TV. First, receive at least one first broadcast data transmitted by television broadcaster. Following that, extract at least one effective data including a preset keyword from the first broadcast data in accordance with the preset keyword and an effective time data corresponding to the at least one effective data, and store an effective time corresponding to the effective time data. Afterward, when a preset time related to the at least one effective time is reached, output a notification signal.

This application claims the benefit of Taiwan application Serial No. 95143425, filed Nov. 23, 2006, the subject matter of which is incorporated herein by reference.

### BACKGROUND OF THE INVENTION

1. Field of the Invention

The invention relates in general to an information notification method, and more particularly to an information notification method applied to a digital TV.

2. Description of the Related Art

When the government or public unit is to notify public information, such as tax paying deadline and typhoon relevant information, it notifies normally via medium such as newspaper and TV news. Without receiving the public information from the medium, the public information may be neglected, which may cause inconvenience.

Besides, when an electric power company plans to cut the power, it will also notify people of the power cut information on medium, such as newspaper and news beforehand. If people do not know the power cut information via the medium beforehand, they may not turn off the electric equipment in time before the power cut, and the electric equipment may be broken down as the power is suddenly regained later.

### SUMMARY OF THE INVENTION

The invention is directed to an information notification method. An effective data required by the user is caught from a broadcast data sent out by television broadcast equipment to obtain an effective time corresponding to the effective data. When a preset time related to an effective time is reached, a digital TV displays a notification signal to inform the user of an event related to the effective data.

According to a first aspect of the present invention, an information notification method is provided. The method is applied to a multimedia home platform (MHP) and a digital TV, the method comprising receiving at least one first broadcast data sent out from a television broadcast equipment; extracting at least one effective data comprising a preset keyword from the first broadcast data in accordance with the preset keyword and extracting an effective time data corresponding to the at least one effective data, and storing an effective time corresponding to the effective time data; and when a preset time related to the effective time is reached, outputting a notification signal.

According to a second aspect of the present invention, an information notification method is provided. The method is applied to a MHP and a digital TV. The method comprises receiving at least one broadcast data; extracting at least one power cut information from the at least one broadcast data in accordance with a preset keyword and extracting a power cut time data corresponding to the at least one power cut information, and storing a power cut time corresponding to the power cut time data; and when the power cut time is approached, automatically turning off the digital TV.

According to a third aspect of the present invention, a digital TV is provided. The digital TV comprises a communication unit, a memory, a display unit and a processor. The communication unit is for receiving at least one broadcast data via a MHP, wherein the at least one broadcast data is sent out from a television broadcast equipment. The processor is coupled to the communication unit, the display unit and the memory for extracting at least one effective data comprising a preset keyword from the at least one broadcast data in accordance with the preset keyword and an effective time data corresponding to the at least one effective data, and storing an effective time corresponding to the effective time data into the memory. When the processor determines that a preset time related to the effective time is reached, a notification signal is displayed on the display unit.

The invention will become apparent from the following detailed description of the preferred but non-limiting embodiments. The following description is made with reference to the accompanying drawings.

### BRIEF DESCRIPTION OF THE DRAWINGS

FIG. 1 is a flow chart of an information notification method according to an embodiment of the invention.

FIG. 2 is a flow chart of an information notification method according to another embodiment of the invention.

FIG. 3 is a flow chart of how to turn off the digital TV according to the power cut information.

FIG. 4 is a block diagram of a digital TV according to the embodiment of the invention.

### DETAILED DESCRIPTION OF THE INVENTION

When the digital TV obtains a broadcast data via a multimedia home platform (MHP), the government or public unit can notify public information, such as the power cut information and typhoon relevant information by using television broadcast equipment, such as T-government. The information notification method of the embodiment of the invention is applied to a digital TV to select the required information from a broadcast data transmitted by the television broadcast equipment in accordance with a preset keyword preset by the user. From the broadcast data, an effective data related to the preset keyword is selected and extracted, and an effective time data corresponding to the effective data is stored. The effective time data is corresponding to an effective time. When a preset time related to the effective time is reached, a corresponding notification signal is displayed on the digital TV to notify the user.

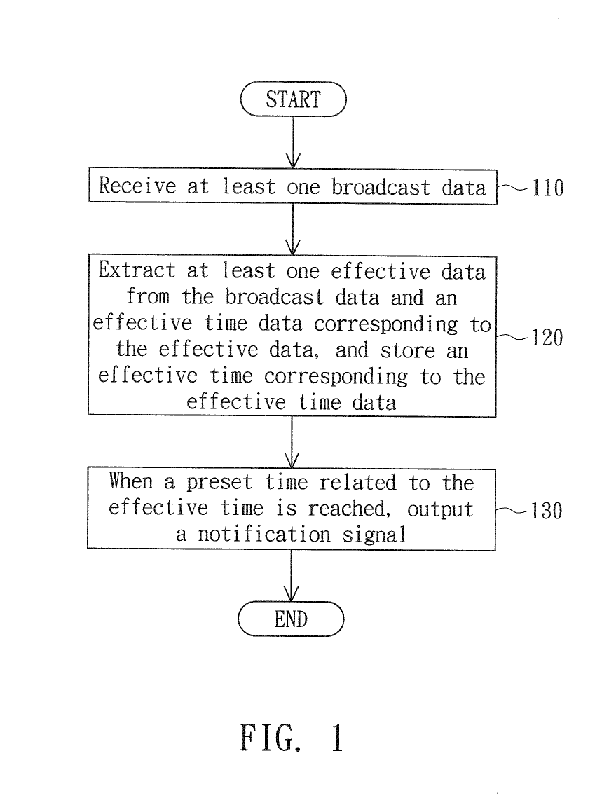

Referring to FIG. 1, a flow chart of an information notification method according to an embodiment of the invention is shown. First, in step 110, receive at least a broadcast data via a MHP. For example, the broadcast data is the public information, such as power cut information or tax paying deadline and is sent out by television broadcast equipment. Afterward, in step 120, extract at least one effective data including a preset keyword preset by the user in accordance with the preset keyword and an effective time data corresponding to the effective data, and store an effective time corresponding the effective time data. Following that, in step 130, when a preset time related to the effective time is reached, output a notification signal to notify the user of an event related to the effective data.

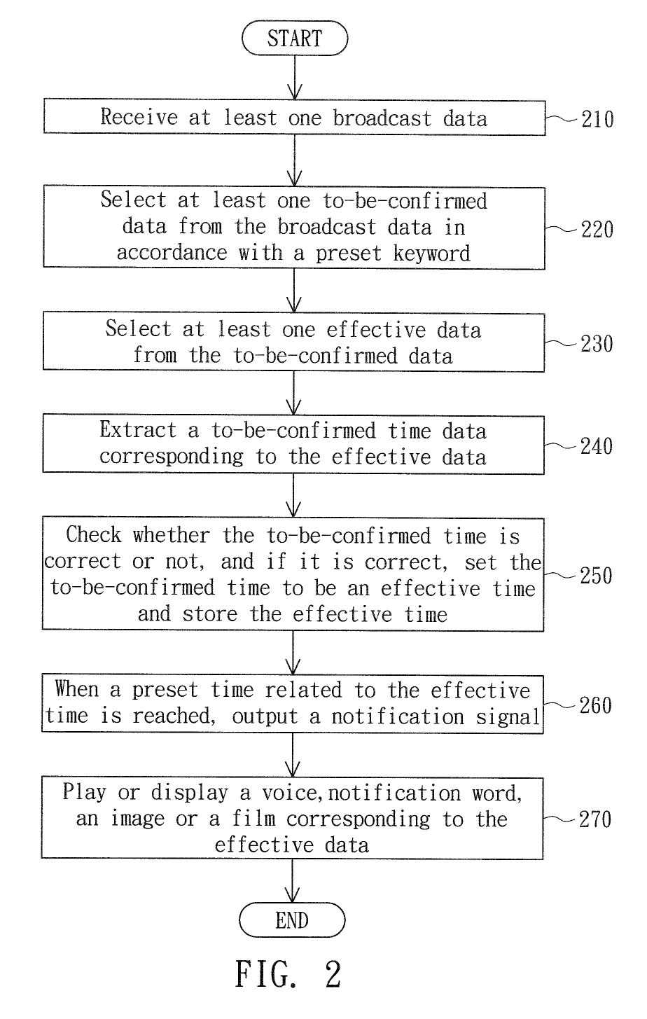

Referring to FIG. 2, a flow chart of an information notification method according to another embodiment of the invention is shown. First, in step 210, the same as the step 110 of FIG. 1, receive at least one broadcast data sent out from the television broadcast equipment. Following that, in step 220, select at least one to-be-confirmed data from the broadcast data in accordance with the preset keyword by a digital TV. Owing that the to-be-confirmed data selected by the digital TV according to the preset keyword may not be the user required data, the user has to further select the required effective data from the to-be-confirmed data. Therefore, in the step 230, select an effective data from the to-be-confirmed data by the user.

Next, in step 240, extract a to-be-confirmed time data corresponding to the effective data by the digital TV. The to-be-confirmed time data is corresponding to a to-be-confirmed time. Owing that the to-be-confirmed time data extracted by the digital TV may not be correct, the user has to further make sure about its correctness. Therefore, in step 250, check whether the to-be-confirmed time is correct or not by the user. If the to-be-confirmed time is correct, set the to-be-confirmed time is an effective time. Thus, the to-be-confirmed time is set to be the effective time and stored. If the user determines the to-be-confirmed time to be incorrect, the user sets an effective time.

Afterward, in step 260, the same as the step 130 of FIG. 1, when a preset time related to the effective time is reached, output a notification signal. In the embodiment, after the step 260, the method further includes a step 270. In the step 270, play or display a voice, notification word, an image or a film corresponding to the effective data to notify the user of an event related to the effective data.

Besides, the step 130 of FIG. 1 or the step 260 of FIG. 2 can also be implemented by the following method. Owing that the digital TV continuously receives other broadcast data, it is continuously determined whether present time data corresponding to the broadcast data received at each time reaches the preset time related to the effective time. If yes, output the notification signal.

In the steps 130 and 260, the preset time is set by the user according to the effective time. The preset time can be set to be the same as the effective time, or come before or after the effective time.

Moreover, the notification signal of FIG. 1 or FIG. 2 is an on-screen display (OSD) notification signal. The user can also capture a frame of the digital TV as the notification signal of FIG. 1 or FIG. 2.

The information notification method of the embodiment of the invention can extract a user-required effective data from a broadcast data sent by television broadcast equipment according to a user-set preset keyword and obtain an effective time corresponding to the effective data. When a preset time related to the effective time is reached, the digital TV displays a notification signal to inform the users of the digital TV about the public information sent by the government, thereby reducing the possibility that the users may neglect the public information they are interested in.

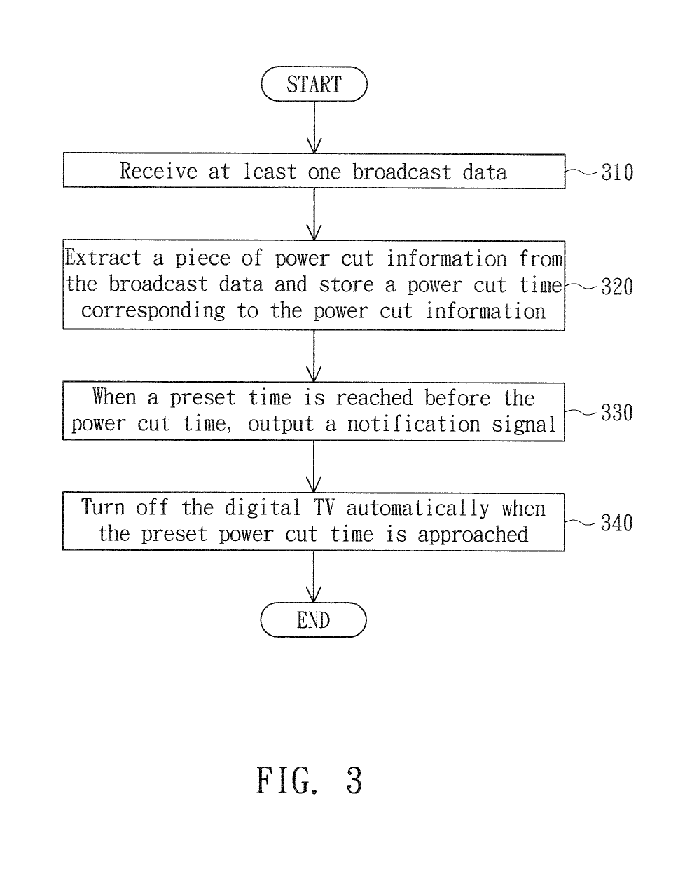

The information notification method of the embodiment of the invention can turn off the digital TV as the power cut time is approached according to the power cut information sent out by the television broadcast equipment. In the following description, FIG. 3 is used for illustrating how the information notification method of the embodiment of the invention turns off the digital TV before the power is cut down according to the power cut information. FIG. 3 is a flow chart of how to turn off the digital TV according to the power cut information. First, in step 310, receive at least a broadcast data. Following that, in step 320, extract a piece of power cut information from the broadcast data and store a power cut time corresponding to the power cut information.

The step 320 can also be implemented by the following method. In step 320, select a to-be-confirmed data from the broadcast data by the digital TV and then check whether the to-be-confirmed data is correct or not and select the required power cut information from the to-be-confirmed data by a user. Following that, extract a to-be-confirmed time data corresponding to the power cut information by the digital TV. The to-be-confirmed data is corresponding to a to-be-confirmed time. Then, check whether the to-be-confirmed time is correct by the user. If the to-be-confirmed time is determined to be correct, set the to-be-confirmed time to be the above power cut time. If the to-be-confirmed time is determined to be incorrect, set a power cut time by the user.

Next, in step 330, when a preset time is reached before the power cut time, output a notification signal to inform the user that a power cut event corresponding to the power cut information is going to occur. Afterward, in step 340, automatically turn off the digital TV to protect the digital TV from being affected by the power cut event if the digital TV is still operating as the preset power cut time is approached.

The information notification method according to the embodiment is exemplified to select the required information from the T-government. However, it is not limited thereto. In practice, the information notification method of the invention is applicable to select the required information from any television broadcast equipment.

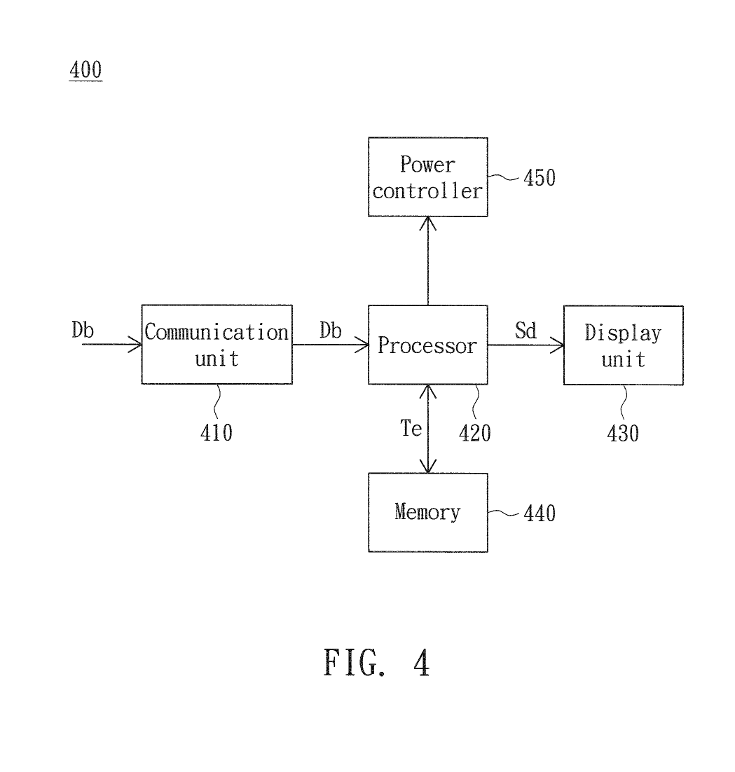

FIG. 4 is a block diagram of a digital TV according to the embodiment of the invention. A digital TV 400 includes a communication unit 410, a processor 420, a display unit 430 and a memory 440. The communication unit 410 receives a broadcast data Db sent by T-government broadcast equipment via a MHP and transmits the broadcast data Db to the processor 420.

The processor 420 extracts an effective data including a preset keyword from the broadcast data Db and an effective time data corresponding to the effective data according to the preset keyword. The processor 420 stores an effective time Te corresponding to the effective time data in the memory 440.

When the processor 420 determines that a preset time related to the effective time Te is reached, a notification signal Sd is displayed on the display unit 430 to inform the user of an event corresponding to the effective data.

The digital TV 400 includes a power controller 450. When the effective data is related to a power cut information notified by the government, the effective time data is a power cut time data corresponding to the power cut information. The effective time Te is the power cut time corresponding to the power cut information. The processor 420 controls the power controller 450 to turn off the digital TV 400 as the power cut time is approached to protect the digital TV 400 from being broken down due to sudden power failure.

The information notification method of the embodiment of the invention can timely inform users of the digital TV about the public information they are interested in. The method can select the power cut information from the broadcast data sent by the television broadcast equipment to inform the user that the power cut event corresponding to the power cut information is going to occur, and turn off the digital TV on time to protect the digital TV from being broken down due to sudden power failure.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An information notification method, applied to a multimedia home platform (MHP) and a digital TV, the method comprising:
(a) receiving at least one first broadcast data transmitted by a television broadcast equipment;
(b) extracting at least one effective data comprising a preset keyword from the at least one first broadcast data in accordance with the preset keyword;
(c) extracting an effective time data corresponding to the at least one effective data, and storing an effective time corresponding to the effective time data; and
(d) outputting a notification signal when a preset time related to the effective time is reached.

2. The method according to claim 1, wherein the step (b) comprises:
(b-1) extracting at least one to-be-confirmed data comprising the preset keyword from the at least one first broadcast data in accordance with the preset keyword; and
(b-2) extracting the at least one effective data from the at least one to-be-confirmed data and storing the effective time corresponding to the at least one effective data.

3. The method according to claim 2, wherein the step (b-2) comprises:
(b-2-1) selecting the at least one effective data from the at least one to-be-confirmed data;
(b-2-2) obtaining a to-be-confirmed time data corresponding to the at least one effective data, wherein the to-be-confirmed time data is corresponding to a to-be-confirmed time; and
(b-2-3) setting the to-be-confirmed time to be the effective time and storing the effective time if the to-be-confirmed time is determined to be correct.

4. The method according to claim 3, wherein in the step (b-2-3), the method further comprises:
if the to-be-confirmed time is determined to be incorrect, setting and storing the effective time by a user, wherein the operation of determining the to-be-confirmed time to be correct or incorrect is performed by the user.

5. The method according to claim 1, wherein the step (c) comprises:
receiving second broadcast data, wherein the second broadcast data comprises a present time data corresponding to a present time; and
if the present time reaches the preset time, outputting the notification signal.

6. The method according to claim 1, wherein after the step (d), the method further comprises:
(d) playing or displaying a voice, a notification word, an image or a film corresponding to the at least one effective data.

7. The method according to claim 1, wherein in the step (b), the at least one effective data is related to a piece of power cut information and the effective time data is a power cut time data corresponding to a power cut time.

8. The method according to claim 7, wherein in the step (d), when the preset time is reached, the notification signal is outputted to notify a user that a power cut event corresponding to the power cut information is going to occur, wherein the preset time comes earlier than the power cut time.

9. The method according to claim 7, further comprising:
(d) when the power cut time is approached, automatically turning off the digital TV.

10. The method according to claim 1, wherein the preset keyword is set by a user, after the at least one to-be-confirmed data is extracted from the at least one first broadcast data, the user selects the at least one effective data from the at least one to-be-confirmed data, the at least one effective data is related to a piece of public information comprising the preset keyword, and the notification signal is related to the public information corresponding to the at least one effective data.

11. The method according to claim 1, wherein the step (d) further comprises setting the preset time by a user.

12. The method according to claim 1, wherein the notification signal is an on-screen display (OSD) signal.

13. The method according to claim 3, wherein a user captures a frame of the digital TV as the notification signal.

14. An information notification method, applied to a MHP and a digital TV, the method comprising:
(a) receiving at least one broadcast data;
(b) extracting at least one power cut information from the at least one broadcast data in accordance with a preset keyword;
(c) extracting a power cut time data corresponding to the at least one power cut information, and storing a power cut time corresponding to the power cut time data; and
(d) automatically turning off the digital TV when the power cut time is approached.

15. The method according to claim 14, wherein between the steps (c) and (d), the method further comprises:
when a preset time is reached before the power cut time, outputting a notification signal to notify a user that a power cut event corresponding to the power cut information is going to occur.

16. A digital TV, comprising:
a communication unit, for receiving at least one broadcast data via a MHP, wherein the at least one broadcast data transmitted by a television broadcaster;
a memory;
a display unit; and
a processor, coupled to the communication unit, the display unit and the memory for extracting at least one effective data comprising a preset keyword from the at least one broadcast data in accordance with the preset keyword and an effective time data corresponding to the at least one effective data, and storing an effective time corresponding to the effective time data into the memory;
wherein when the processor determines that a preset time related to the effective time is reached, a notification signal is displayed on the display unit.

17. The digital TV according to claim 16, wherein when the processor determines that the preset time is reached, the display unit plays or displays a notification word, an image or a film corresponding to the at least one effective data.

18. The digital TV according to claim 16, wherein the at least one effective data is related to a power cut information, the effective time data is a power cut time data corresponding to a power cut time.

19. The digital TV according to claim 18, wherein the notification signal is used for notifying a user that a power cut event corresponding to the power cut information is going to occur.

20. The digital TV according to claim 18, further comprising a power controller, wherein when the power cut time is approached, the processor controls the power controller to turn off the digital TV.
